(19) United States
(12) Patent Application Publication
(10) Pub. No.: US 2018/0234537 A1
(43) Pub. Date: Aug. 16, 2018

(54) MESSAGING SYSTEM WITH CONFIGURABLE IDENTIFICATION

(71) Applicant: Sheng-Chun Lin, New Taipei City (TW)

(72) Inventor: Sheng-Chun Lin, New Taipei City (TW)

(21) Appl. No.: 15/430,542

(22) Filed: Feb. 13, 2017

(51) Int. Cl. H04M 1/725; H04L 12/18; G06F 3/0482; G06F 3/0484

(52) U.S. Cl. CPC H04M 1/72552; H04L 12/185; H04L 12/189; G06F 3/0484; G06F 3/0482

(57) ABSTRACT

The messaging system allows a user to define multiple and different identifications for communicating with different groups of other users. A configuration unit is for defining and modifying an identification for each group. A selection unit provides a list of identifications for the user to choose. Once an identification is selected, corresponding contacts belonging to the same group is provided by a roster unit. Furthermore, the provided contacts may be sorted in various order to facilitate communications. By changing identifications for different groups of correspondent, the messaging system is friendlier and more convenient.

### BACKGROUND OF THE INVENTION

### (a) Technical Field of the Invention

The present invention is generally related to messaging systems and more particular to a messaging system where a user may define multiple and different identifications for communicating with different groups of other users.

### (b) Description of the Prior Art

Messaging is a common requirement in the daily life. Especially in this Internet era when everyone possesses a mobile phone, people are constantly communicating with each other through various messaging systems. Existing messaging systems only allow a user to have a single identification, and the same identification is used for all correspondents. The identification cannot be modified after it is created and there is no authentication mechanism so that fraud is not uncommon.

### SUMMARY OF THE INVENTION

A major objective of the present invention is to provide a messaging system with a configuration unit so that a user may define different identifications for different groups of correspondents so as to enhance the versatility and privacy of the messaging system.

Another objective of the present invention is that indicators are provided for all contacts to indicate whether there is unread messages from the corresponding contacts, thereby enhancing the convenience and usability of the messaging system.

To achieve the objectives, the messaging system includes a roster unit, a selection unit, and a configuration unit. The roster unit includes a number of contacts where each contact is associated with an indicator and a group. The indicator indicates at least an unread message from the corresponding contact and a group. The selection unit provides a number of identifications where each identification is associated with a group and an identification datum. The configuration unit is for defining an identification for a group and modifying the identification data of the identifications. When an identification is selected through the selection unit, a list of contacts associated with the group corresponding to the identification is provided by the roster unit. In other words, a user may assume various identifications for communicating with correspondents of different groups, thereby protecting the privacy of the user.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings, identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a functional block diagram showing a messaging system according to an embodiment of the present invention.

FIG. 2 is a schematic diagram showing a list of contacts on a screen of the messaging system of FIG. 1.

FIG. 3 is a schematic diagram showing a list of identifications on a screen of the messaging system of FIG. 1.

FIG. 4 is a schematic diagram showing a list of groups on a screen of the messaging system of FIG. 1.

### DETAILED DESCRIPTION OF THE PREFERRED EMBODIMENTS

The following descriptions are exemplary embodiments only and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

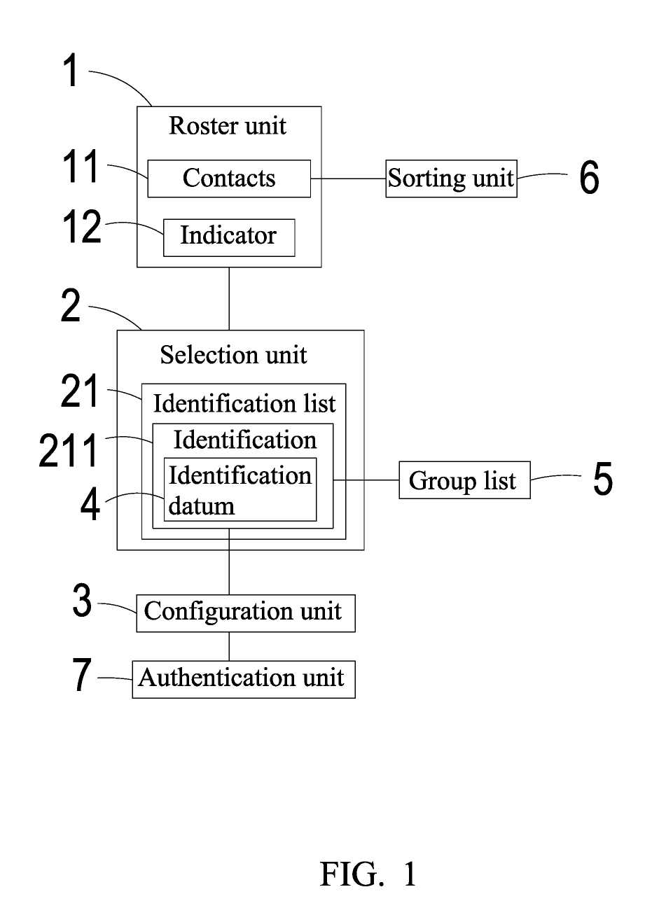

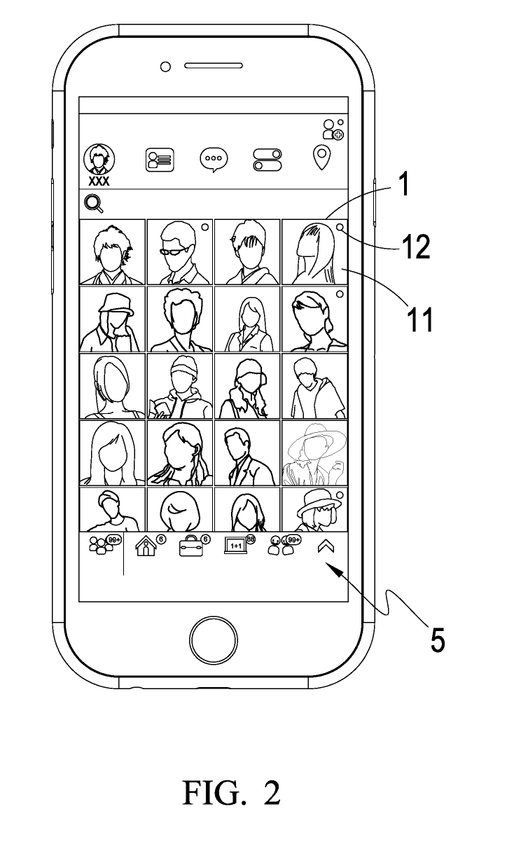

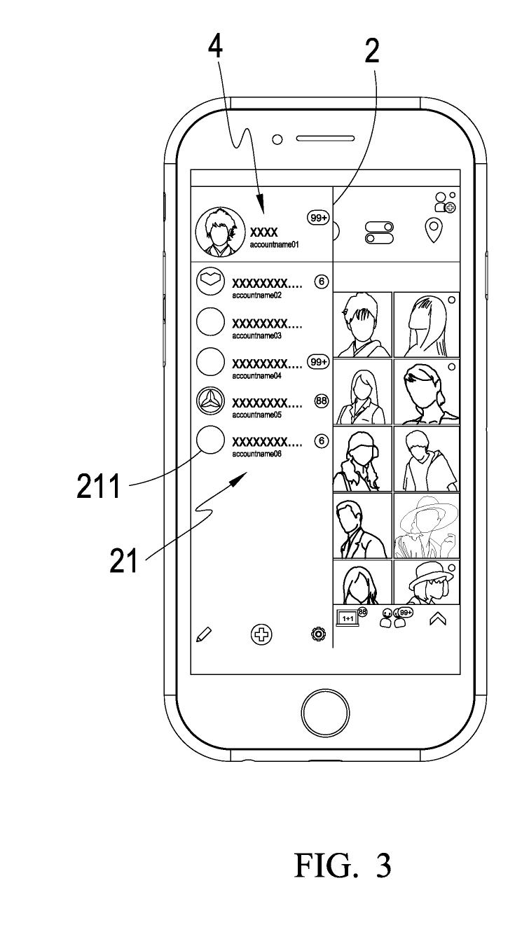

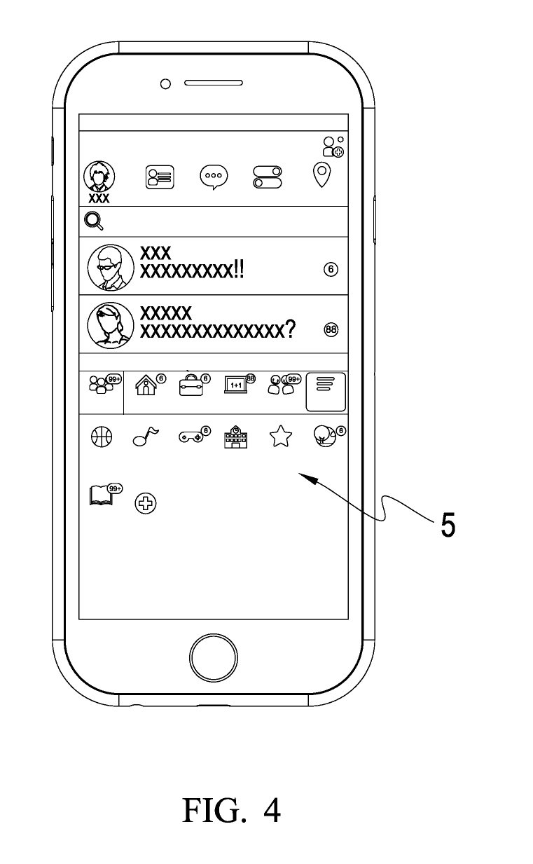

As shown in FIGS. 1 to 4, a messaging system with configurable identification according to an embodiment of the present invention includes the following components.

From a user's perspective, there is a roster unit 1 shown on a screen of the user including at least a contact 11. Each contact 11 is represented by a contact representation. When there is a message from a contact 11 to the user, an indicator 12 is associated with the contact representation of the contact 11 on the screen. The indicator 12 may be a colored dot or a number indicating the number of unread messages from the contact 11 to the user.

There is a selection unit 2 shown on the screen to a side of a list of contacts 11 of the roster unit 1. The selection unit 2 provides a list of identifications 21 includes at least an identification 211. Each identification 211 is associated with a group. When the user selects a specific identification 211 through the selection unit 2, the representations of the contacts 11 belonging to the same group are displayed in the list of contacts. The identification 211 is the identification of the user when communicating with the contacts 11 of the same group.

Each identification 211 includes at least a identification datum 4 which involves at least a name When the user selects an identification 211, the corresponding identification datum 4 is shown in in the screen above the list of identifications 21. The user is able to modify the identification datum 4 for the group through a configuration unit 3 (not shown).

There is also a list of groups 5 shown on the screen including all the groups created by the user. Each group is associated with a number of contacts 11 belonging to the group and an identification 211 used by the user in communicating with the contacts 11 of the same group. There is also a sorting unit 6 (not shown) for arranging the contacts 11 in shown in the list of contacts in a specific order.

There is also an authentication unit 7 data-linked with the configuration unit 3 for verifying the identification datum.

A user, therefore, registers an account and becomes a valid user first. Then whether the entered identification datum is from a valid user is verified through the authentication unit 7. If authenticated, the user is granted access to the messaging system.

When the user wants to communicates, the user activates the selection unit 2 and selects an identification 211 from the list of identifications 21. The roster unit 1 then presents a list of contacts 11 belonging to a same group as the identification 211. Alternatively, the user may also pick a group from the list of groups 5 on the screen. Once a group is chosen, similarly, a list of contacts 11 belonging to the group is displayed. For example, if the user picks the identification 211 for a group “family” from the list of identifications 21, the roster unit 1 provides the contacts 11 included in the group “family” in the list of contacts. To switch to a different identification, the user activates the selection unit 2 and selects another identification 211. Again, the roster unit 1 provides a different list of contacts corresponding to the group associated with the newly selected identification 211.

The user may set or modify the identification datum 4 of any one of his/her identifications 211 at any time through the configuration unit 3. For example, if the user sets his name as “Jobs” in a first group associated with one of his identifications 211, all contacts 11 within the first group would see his name as “Jobs.” Similarly, if the user sets his name as “Alice” in a second group associated with another one of his identifications 211, all contacts 11 within the second group would see his name as “Alice.”

In addition, if one of the contacts 11 shown in the list of contacts sends a message to the user, the indicator 12, for example, a red dot, would prompt the user to read the message. Alternatively, the indicator 12 may be a number indicating the number of unread messages from the contact 11.

The user may order the contacts 11 in the list of contacts through the sorting unit 6. For example, those with unread messages are arranged on top of the list, or those with more unread messages are located closer to the top of the list.

Therefore, the gist of the present invention lies in the following.

Firstly, through the configuration unit 3, a user is able to define different identifications 211 for different groups, thereby enhancing diversity and privacy significantly.

Secondly, the user is prompted by the indicators 12 regarding unread messages, thereby enhancing the system's convenience and usability.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A messaging system with configurable identification, comprising
a roster unit comprising a plurality of contacts where each contact is associated with an indicator indicating at least an unread message from the corresponding contact;
a selection unit providing a plurality of identifications where each identification is associated with a group and an identification datum; and
a configuration unit for defining an identification for a group and modifying the identification data of the identifications.

2. The messaging system according to claim 1, wherein each contact is associated with a group.

3. The messaging system according to claim 2, wherein, when an identification is selected through the selection unit, a list of contacts associated with the group corresponding to the identification is provided by the roster unit.

4. The messaging system according to claim 3, further comprising a sorting unit arranging the list of contacts in a user-specified order.

5. The messaging system according to claim 1, wherein the indicator is represented on a screen of the messaging system as one of a colorful graph or a number indicating the number of unread messages.

6. The messaging system according to claim 1, further comprising an authentication unit data-linked with the configuration unit authenticating whether the identification datum entered through the configuration unit is from a valid user.
